(19) United States
(12) Patent Application Publication
(10) Pub. No.: US 2025/0247506 A1
(43) Pub. Date: Jul. 31, 2025

(54) DISPLAY METHOD, PROJECTOR, AND RECORDING MEDIUM ON WHICH PROGRAM IS RECORDED

(71) Applicant: SEIKO EPSON CORPORATION, Tokyo (JP)

(72) Inventor: Morio MATSUMOTO, MATSUMOTO-SHI (JP)

(21) Appl. No.: 19/036,493

(22) Filed: Jan. 24, 2025

(30) Foreign Application Priority Data
Jan. 26, 2024 (JP) 2024-010010

(51) Int. Cl. H04N 9/31

(52) U.S. Cl. CPC H04N 9/3147; H04N 9/3188

(57) ABSTRACT

A display method includes determining first resolution of each of first and second projection images that first and second projectors are configured to project; and displaying multiple options for defining an entire image configured with the first and second projection images, the multiple options each including at least one of second resolution indicating resolution of the entire image and an aspect ratio of the entire image, and displaying the multiple options including causing a display mode of an option corresponding to resolution and an aspect ratio that satisfy a condition of at least one parameter that defines the entire image out of the multiple options to differ from a display mode of another option based on the first resolution.

The present application is based on, and claims priority from JP Application Serial Number 2024-010010, filed Jan. 26, 2024, the disclosure of which is hereby incorporated by reference herein in its entirety.

### BACKGROUND

### 1. Technical Field

The present disclosure relates to a display method, a projector, and a recording medium on which a program is recorded.

### 2. Related Art

For example, JP-A-2013-117631 discloses a projection system including an acquisition section that acquires, from each projection apparatus, the number of pixels of an image suitable for a projection screen and the number of pixels of an overlapping region of the projection screen, and a calculation section that calculates the number of pixels of an integrated screen from the number of pixels of the projection screen and the number of pixels of the overlapping region acquired by the acquisition section.

JP-A-2013-117631 is an example of the related art. In JP-A-2013-117631, the number of pixels of the integrated screen changes in accordance with the number of pixels of an image projected by each of the projection apparatuses. However, the technology described in JP-A-2013-117631, in which the number of pixels of the integrated screen is simply calculated, has such a problem that it is difficult for a user to intuitively grasp the properties of the integrated screen.

### SUMMARY

A display method according to an aspect of the present disclosure is a display method for causing a first projection image projected from a first projector onto a projection surface and a second projection image projected from a second projector onto the projection surface to partially overlap with each other in an overlap region of the projection surface, the display method including: determining first resolution of each of the first and second projection images that the first and second projectors are configured to project; and displaying multiple options for defining an entire image configured with the first and second projection images, the multiple options each including at least one of second resolution indicating resolution of the entire image and an aspect ratio of the entire image, and displaying the multiple options including causing a display mode of an option corresponding to resolution and an aspect ratio that satisfy a condition of at least one parameter that defines the entire image out of the multiple options to differ from a display mode of another option based on the first resolution.

A projector according to an aspect of the present disclosure is a projector used as a first projector when a first projection image projected from the first projector onto a projection surface and a second projection image projected from a second projector onto the projection surface are caused to partially overlap with each other in an overlap region of the projection surface, the projector including: an optical apparatus; and a processing apparatus configured to control an operation of the optical apparatus, the processing apparatus configured to determine first resolution of each of the first and second projection images that the first and second projectors are configured to project, and display multiple options for defining an entire image configured with the first and second projection images, the multiple options each including at least one of second resolution indicating resolution of the entire image and an aspect ratio of the entire image, displaying the multiple options including causing a display mode of an option corresponding to resolution and an aspect ratio that satisfy a condition of at least one parameter that defines the entire image out of the multiple options to differ from a display mode of another option based on the first resolution.

A recording medium on which a program is recorded according to an aspect of the present disclosure is a recording medium on which a program is recorded for causing a first projection image projected from a first projector onto a projection surface and a second projection image projected from a second projector onto the projection surface to partially overlap with each other in an overlap region of the projection surface, the recording medium on which a program is recorded causing a computer to: determine first resolution of each of the first and second projection images that the first and second projectors are configured to project; and display multiple options for defining an entire image configured with the first and second projection images, the multiple options each including at least one of second resolution indicating resolution of the entire image and an aspect ratio of the entire image, and displaying the multiple options including causing a display mode of an option corresponding to resolution and an aspect ratio that satisfy a condition of at least one parameter that defines the entire image out of the multiple options to differ from a display mode of another option based on the first resolution.

### BRIEF DESCRIPTION OF THE DRAWINGS

FIG. 1 shows an overview of a system used to perform a display method according to a first embodiment.

FIG. 2 is a block diagram of a projector according to the first embodiment.

FIG. 3 is a flowchart showing the procedure of the display method according to the first embodiment.

FIG. 4 show an example of a setting image.

FIG. 5 illustrates a selection operation performed on the setting image.

FIG. 6 illustrates a setting image after resolution is set.

FIG. 7 illustrates the settings of a pair of the resolution and an aspect ratio of an entire image.

FIG. 8 shows an example of displayed multiple options showing pairs of the resolution and the aspect ratio of the entire image.

FIG. 9 illustrates the relationship of the resolution and the aspect ratio of the entire image with the resolution and the aspect ratio of light modulators.

FIG. 10 illustrates an example of pairs of the resolution and the aspect ratio of the entire image.

FIG. 11 illustrates an example of pairs of the resolution and the aspect ratio of the entire image.

FIG. 12 shows another example of displayed multiple options showing pairs of the resolution and the aspect ratio of the entire image.

FIG. 13 illustrates an example of pairs of the resolution and the aspect ratio of the entire image.

FIG. 14 illustrates an example of pairs of the resolution and the aspect ratio of the entire image.

FIG. 15 illustrates an example of pairs of the resolution and the aspect ratio of the entire image.

FIG. 16 is a block diagram of a terminal apparatus used to perform a display method according to a second embodiment.

FIG. 17 is a flowchart showing the procedure of the display method according to the second embodiment.

### DESCRIPTION OF EMBODIMENTS

Preferable embodiments according to the present disclosure will be described below with reference to the accompanying drawings. Note in the drawings that the dimension and scale of each portion differs from actual values as appropriate, and that some portions are diagrammatically shown for ease of understanding. The scope of the present disclosure is not limited to the embodiments unless the following description particularly states that restrictions are imposed on the present disclosure.

### 1. First Embodiment

### 1-1. Overview of Multi-Projection System

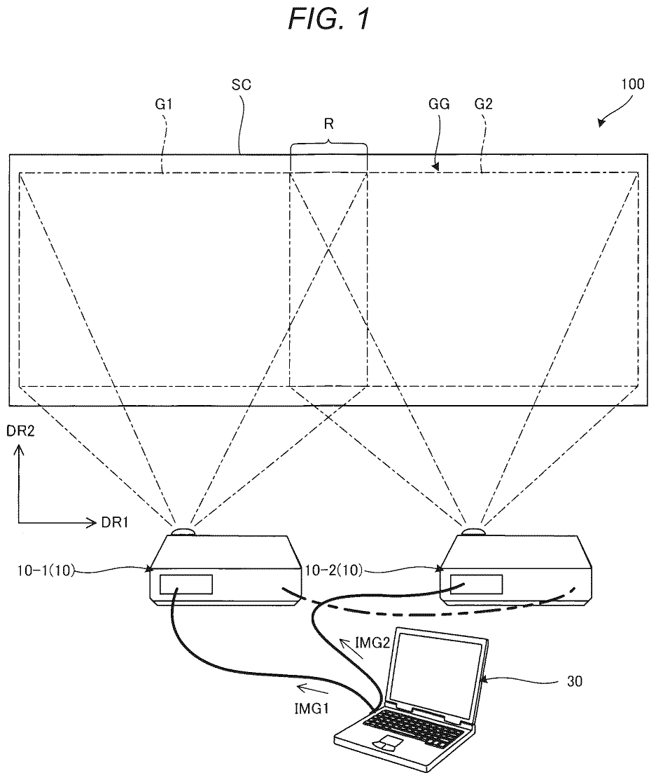

FIG. 1 shows an overview of a system 100 used to perform a display method according to a first embodiment. The system 100 is a multi-projection system that projects an entire image GG configured with a first projection image G1 and a second projection image G2 onto a projection surface SC.

The projection surface SC is the surface of an object, such as a screen. In the example shown in FIG. 1, the projection surface SC is a planar surface. The projection surface SC is not limited to the planar surface, and may, for example, be a curved surface.

The system 100 includes a first projector 10-1, a second projector 10-2, and a terminal apparatus 30, as shown in FIG. 1. The first projector 10-1 is an example of a “projector”. In the following description, the first projector 10-1 and the second projector 10-2 are not distinguished other but are referred to as projectors 10 in some cases. Note that the present embodiment will be described with reference to an aspect in which the system 100 includes two projectors 10, but not necessarily, and may include three or more projectors 10. That is, the entire image GG may contain images projected from three or more projectors 10.

The first projector 10-1 is a display apparatus that projects the first projection image G1, which is indicated by video data IMG1 output from the terminal apparatus 30, onto the projection surface SC. The second projector 10-2 is a display apparatus that projects the second projection image G2, which is indicated by video data IMG2 output from the terminal apparatus 30, onto the projection surface SC.

The first projection image G1 and the second projection image G2 are arranged in this order in a first direction DR1, and constitute the entire image GG. The first projection image G1 and the second projection image G2 are projected onto the projection surface SC with the two images joined to each other so that the entire image GG is displayed as a single image. In the example shown in FIG. 1, the entire image GG has a rectangular shape having a lateral direction that coincides with the first direction DR1 and a longitudinal direction that coincides with a second direction DR2 perpendicular to the first direction DR1. The first projection image G1 is projected onto a left region of the projection surface SC in FIG. 1, whereas the second projection image G2 is projected onto a right region of the projection surface SC in FIG. 1. A portion of the first projection image G1 that includes the right end in FIG. 1 and a portion of the second projection image G2 that includes the left end in FIG. 1 are joined each other. That is, the portion of the first projection image G1 that includes the right end in FIG. 1 is superimposed on the portion of the second projection image G2 that includes the left end in FIG. 1.

The first projection image G1 and the second projection image G2 described above partially overlap with each other in an overlap region R. The overlap region R is a region where blending is performed to make the joint between the first projection image G1 and the second projection image G2 less noticeable. The system 100 thus performs a display method for causing the first projection image G1 projected onto the projection surface SC from the first projector 10-1 and the second projection image G2 projected onto the projection surface SC from the second projector 10-2 to partially overlap with each other in the overlap region R of the projection surface SC.

In the present embodiment, the first projector 10-1 is a primary projector and controls the operation of the second projector 10-2, which is a secondary projector. The first projector 10-1 has a setting function of setting the resolution and the aspect ratio of the entire image GG. In the setting function, the first projector 10-1 can accept a selection operation of selecting one type of resolution of from multiple types of resolutions at which the first projector 10-1 can project an image, sets the resolution of each of the first projection image G1 and the second projection image G2 based on the selection operation, and displays multiple options from which one pair of the resolution and the aspect ratio of the entire image GG is selected. Note that the second projector 10-2 may have a configuration different from that of the first projector 10-1 as long as the operation of the second projector 10-2 can be controlled by the first projector 10-1. When the system 100 includes three or more projectors 10, one projector 10 is the primary projector, and the other two or more projectors 10 are secondary projectors out of the three or more projectors 10. The resolution of an image that each of the projectors 10 can project is hereinafter referred to as “panel resolution”, “the number of panel pixels”, or “a screen type” in some cases. The aspect ratio of the entire image GG is referred to as a “coupled aspect ratio” in some cases.

The terminal apparatus 30 is an apparatus having the function of dividing video data representing a single image into multiple sets of video data to be projected by the multiple projectors 10, and the function of supplying the divided sets of video data to the corresponding projectors 10.

The terminal apparatus 30 in the present embodiment divides video data representing a single image into the video data IMG1 and the video data IMG2, and then supplies the image data IMG1 and the image data IMG2 to the first projector 10-1 and the second projector 10-2, respectively.

In the example shown in FIG. 1, the terminal apparatus 30 is a laptop computer having a liquid crystal display. Note that the terminal apparatus 30 is not limited to a laptop computer and may, for example, be a desktop computer, a smartphone, or a tablet terminal or may be a video reproduction apparatus, a DVD (digital versatile disk) player, a Blu-ray disc player, a hard disk recorder, a television tuner, a set-top box for CATV (cable television), a video game console, or the like.

### 1-2. Projector

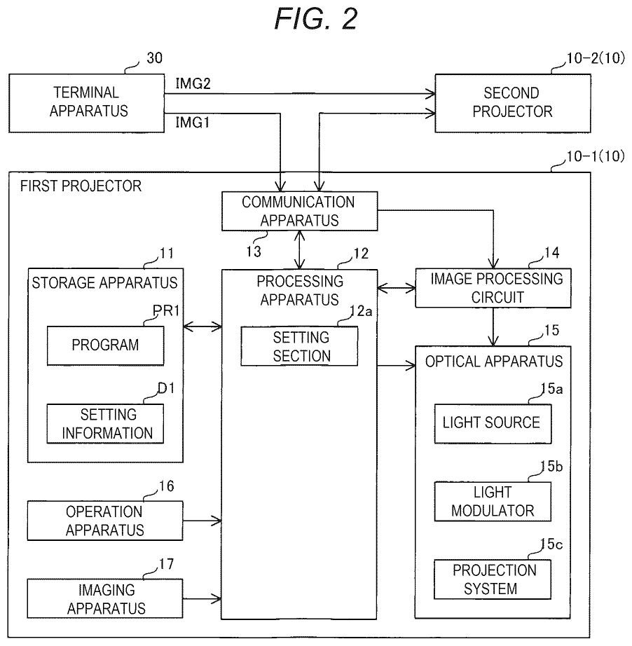

FIG. 2 is a block diagram of the first projector 10-1 according to the first embodiment. FIG. 2, which shows the first projector 10-1, further shows how the second projector 10-2 and the terminal apparatus 30 are coupled to the first projector 10-1. In FIG. 2, which representatively shows the configuration of the first projector 10-1, the configuration of the second projector 10-2 is the same as the configuration of the first projector 10-1 except that the second projector 10-2 is a secondly projector, and the following description of the elements that constitute the first projector 10-1 also holds true for the second projector 10-2 by replacing the video data IMG1 with the video data IMG2. In the following description of the elements that constitute each of the projectors 10, the elements of the first projector 10-1 and the elements of the second projector 10-2 are distinguished from each other in some cases by adding a suffix “-1” to the reference characters of the elements of the first projector 10-1 and a suffix “-2” to the reference characters of the elements of the second projector 10-2.

The first projector 10-1 is a projector used to cause the first projection image G1 projected onto the projection surface SC from the first projector 10-1 and the second projection image G2 projected onto the projection surface SC from the second projector 10-2 to partially overlap with each other in the overlap region R of the projection surface SC.

The first projector 10-1 includes a storage apparatus 11, a processing apparatus 12, a communication apparatus 13, an image processing circuit 14, an optical apparatus 15, an operation apparatus 16, and an imaging apparatus 17, as shown in FIG. 2. The apparatuses are communicatively connected to each other.

The storage apparatus 11 is a storage apparatus that stores programs to be executed by the processing apparatus 12 and data to be processed by the processing apparatus 12. The storage apparatus 11 includes, for example, a hard disk drive or a semiconductor memory. Note that a portion or the entirety of the storage apparatus 11 may be provided in a storage apparatus, a server, or the like outside the first projector 10-1.

The storage apparatus 11 stores a program PR1 and setting information D1.

The program PRI is a program that performs the display method, which will be described later in detail. That is, the program PRI is a program that causes the first projection image G1 projected onto the projection surface SC from the first projector 10-1 and the second projection image G2 projected onto the projection surface SC from the second projector 10-2 to partially overlap with each other in the overlap region R of the projection surface SC. The setting information D1 is information representing the resolution and the aspect ratio of the entire image GG.

The processing apparatus 12 is a processing apparatus having the function of controlling each section of the first projector 10-1 and the function of processing various kinds of data. The processing apparatus 12 includes, for example, a processor such as a CPU (central processing unit). Note that the processing apparatus 12 may be configured with a single processor or multiple processors. Some or all of the functions of the processing apparatus 12 may be realized by hardware such as a digital signal processor (DSP), an application specific integrated circuit (ASIC), a programmable logic device (PLD), and a field programmable gate array (FPGA). The processing apparatus 12 may be integrated with the image processing circuit 14.

The communication apparatus 13 is a communication apparatus that can communicate with various instruments, acquires the image data IMG1 from the terminal apparatus 30, and communicates with the second projector 10-2. For example, the communication apparatus 13 is a wired communication apparatus using, for example, a wired local area network (LAN), a universal serial bus (USB), or a high-definition multimedia interface (HDMI), or a wireless communication apparatus using, for example, a low-power wide area (LPWA), a wireless LAN including Wi-Fi, or Bluetooth. “HDMI”, “Wi-Fi”, and “Bluetooth” are each a registered trademark.

The image processing circuit 14 is a circuit that performs necessary processing on the video data IMG1 from the communication apparatus 13 and inputs the processed data to the optical apparatus 15. The image processing circuit 14 has, for example, a frame memory that is not shown, loads the video data IMG1 in the frame memory, performs various kinds of processing such as resolution conversion, resizing, and distortion correction as appropriate, and inputs the processed data to the optical apparatus 15. The image processing circuit 14 adjusts the resolution and the aspect ratio of the entire image GG based on the setting information D1 stored in the storage apparatus 11. Note that the image processing circuit 14 performs processing such as OSD (on screen display), which generates image information for a displayed menu, an operation guide, or the like and combines the image information with the video data IMG1 as necessary.

The optical apparatus 15 is an apparatus that projects image light onto the projection surface SC. The optical apparatus 15 includes a light source 15a, a light modulator 15b, and a projection system 15c.

The light source 15a includes a light source such as a halogen lamp, a xenon lamp, an ultrahigh-pressure mercury lamp, a light emitting diode (LED), or a laser light source, and outputs red light, green light, and blue light. The light modulator 15b draws an image based on the video data IMG1 supplied from the terminal apparatus 30. The light modulator 15b includes three light modulating elements provided in correspondence with red, green, and blue. The light modulating elements each have, for example, first sides and second sides that intersect with the first sides. The first sides are, for example, the lateral sides of the light modulating element, and the second sides are the longitudinal sides of the light modulating element. The light modulating elements each include multiple pixels arranged in a matrix. The multiple pixels are arranged in a matrix in a third direction along the first sides and a fourth direction along the second sides. The third direction corresponds to the first direction DR1, and the fourth direction corresponds to the second direction DR2. Each of the light modulating elements is, for example, a transmissive liquid crystal panel, a reflective liquid crystal panel, or a digital mirror device (DMD), and modulates corresponding color light to generate image light of the color. The multiple types of color image light generated by the light modulator 15b are combined with one another by a color synthesis optical system into full-color image light. The projection system 15c is an optical system including a projection lens or the like that brings the full-color image light from the light modulator 15b into focus to project the thus formed image onto the projection surface SC. The image drawn by the light modulator 15b, that is, a drawn image is projected onto the projection surface SC via the projection lens.

The operation apparatus 16 is an apparatus that accepts a user's operation. For example, the operation apparatus 16 includes an operation panel and a remote control light receiver neither of which is shown. The operation panel is provided at an exterior enclosure of the first projector 10-1 and outputs a signal based on the user's operation. The remote control light receiver receives an infrared signal from a remote control that is not shown, decodes the infrared signal, and outputs a signal based on an operation performed on the remote control.

The imaging apparatus 17 is a digital camera including an imaging element such as a CCD (charge coupled device) or a CMOS (complementary metal oxide semiconductor) device. The imaging apparatus 17 images a region containing the region illuminated with the image light projected onto the projection surface SC from the optical apparatus 15.

In the first projector 10-1 described above, the processing apparatus 12 functions as a setting section 12a by executing the program PRI stored in the storage apparatus 11. The processing apparatus 12 therefore includes the setting section 12a.

The setting section 12a sets the resolution and the aspect ratio of the entire image GG. Specifically, the setting section 12a controls the operation of the image processing circuit 14 and the optical apparatus 15 to cause the optical apparatus 15 to display setting images UI, which will be described later and are necessary for setting the resolution and the aspect ratio of the entire image GG. The setting section 12a further performs processing necessary for setting the resolution and the aspect ratio of the entire image GG based on operations performed on the setting images UI via the operation apparatus 16.

In the present embodiment, the processing apparatus 12 acquires imaged data by causing the imaging apparatus 17 to image the image light on the projection surface SC, and uses the acquired imaged data to perform mathematical operation necessary for processing such as image light correction.

As described above, the first projector 10-1 includes the optical apparatus 15 and the processing apparatus 12, which controls the operation of the optical apparatus 15.

1-3. Display method

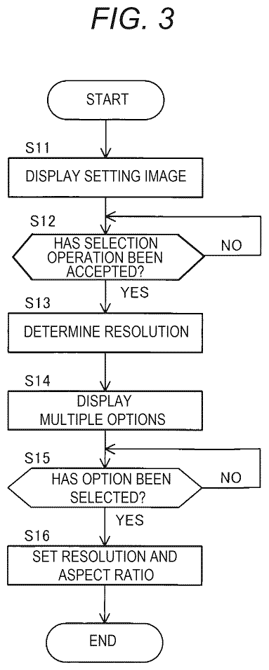

FIG. 3 is a flowchart showing the procedure of the display method according to the first embodiment. The display method is performed by using the system 100 described above to cause the processing apparatus 12 to execute the program PR1. The display method includes steps S11 to S16, as shown in FIG. 3. That is, the processing apparatus 12 of the first projector 10-1 executes steps S11 to S16. The program PR1 causes the processing apparatus 12, which is an example of a computer, to execute steps S11 to S16. The computer is not limited to the processing apparatus 12 and may be any apparatus having the function of controlling the operation of the first projector 10-1. For example, the computer may be an external personal computer coupled to the first projector 10-1.

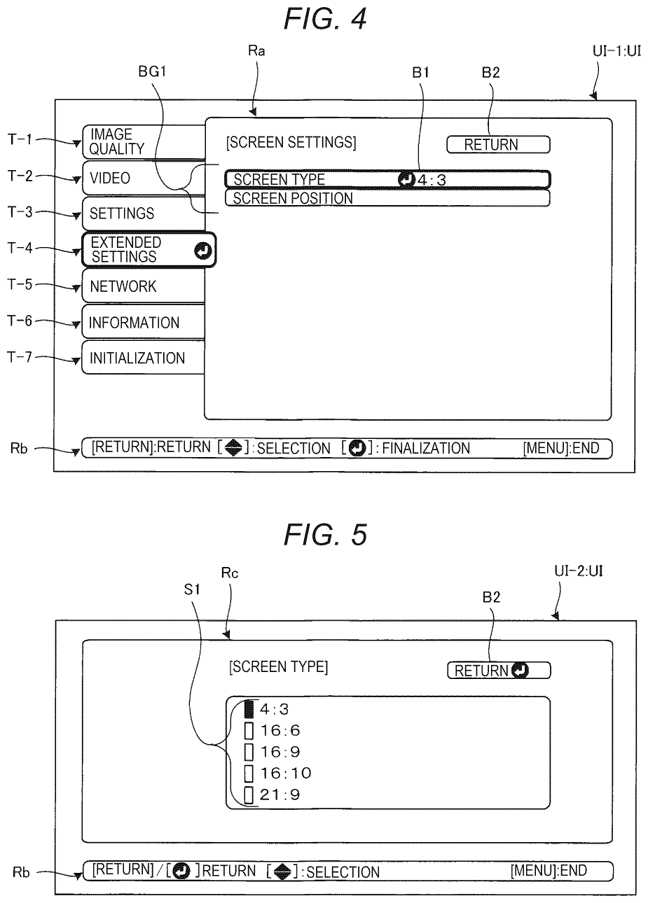

Specifically, in step S11, the setting section 12a first causes the optical apparatus 15 to display the setting images UI, which will be described later. In the present embodiment, the display operation is performed by causing the setting section 12a to control the operation of driving the image processing circuit 14 and the optical apparatus 15 to cause the optical apparatus 15 to project a setting image UI-1, which is shown in FIG. 4 and will be described later, onto the projection surface SC as the first projection image G1. Step S11 starts, for example, in response to activation of the first projector 10-1 or a predetermined operation performed to the operation apparatus 16.

After step S11, the setting section 12a determines in step S12 whether a selection operation of selecting one type of resolution from the multiple types of resolution, at which the first projector 10-1 can project an image, has been accepted. The selection operation is performed by using a setting image UI-2, which is shown in FIG. 5 and will be described later. Step S12 is repeatedly executed until the selection operation is performed (NO in step S12). Note in step S12 that the terminal apparatus 30 may accept the selection operation. In this case, the setting image UI-2, which is shown in FIG. 5 and will be described later, may be displayed on the liquid crystal display of the terminal apparatus 30, or may be projected from the first projector 10-1.

When the selection operation is performed (YES in step S12), the setting section 12a determines in step S13 the resolution of each of the first projection image G1 and the second projection image G2 based on the selection operation in step S12. Specifically, based on the selection operation in step S12, the first projector 10-1 determines maximum resolution of an image to be projected by the first projector 10-1, that is, first resolution, and directly transmits information representing the first resolution to the second projector 10-2. The second projector 10-2 can thus also determine maximum resolution of an image to be projected by the second projector 10-2, that is, the first resolution. Note in step S13 that after the information representing the first resolution is temporarily transmitted from the first projector 10-1 to the terminal apparatus 30, the information representing the first resolution may be transmitted from the terminal apparatus 30 to the second projector 10-2.

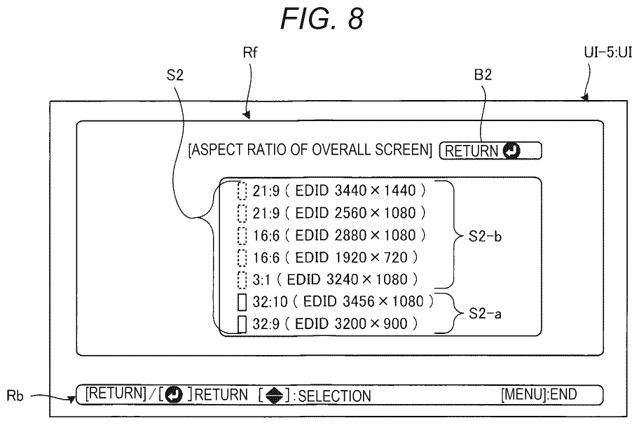

After step S13, the setting section 12a causes in step S14 the optical apparatus 15 to display multiple options S2, which will be described later, for selecting one from the multiple pairs of the resolution and the aspect ratio of the entire image GG, which is configured with the first projection image G1 and the second projection image G2. In the present embodiment, the display operation is performed by causing the setting section 12a to control the operation of driving the image processing circuit 14 and the optical apparatus 15 to cause the optical apparatus 15 to project a setting image UI-5, which is shown in FIG. 8 and will be described later, onto the projection surface SC as the first projection image G1.

After step S14, the setting section 12a determines in step S15 whether one option S2 has been selected from the multiple options S2, which will be described later. Step S15 is repeatedly executed until the operation of selecting one option S2 is performed (NO in step S15).

When one option S2 has been selected (YES in step S15), the setting section 12a sets in step S16 the pair of the resolution and the aspect ratio corresponding to the selected option S2 as the resolution and the aspect ratio of the entire image GG. The content of the setting operation is stored as the setting information D1 in the storage apparatus 11.

The procedure of the display method has been described. An example of the setting image UI used in the display method will be described below with reference to FIGS. 4 to 8. FIGS. 4 to 8 show the setting images UI-1 to UI-5, which transition from one to another in accordance with the progress of the display method. In the following description, the setting images UI-1 to UI-5 may not be distinguished from each other, but are referred to as setting images UI in some cases. The setting images UI are not limited to those shown in FIGS. 4 to 8.

FIG. 4 show an example of the setting images UI. In step S11, the setting image UI-1 is displayed as shown, for example, in FIG. 4.

The setting images UI are graphical user interface (GUI) images for various settings of the first projector 10-1, and can accept an operation performed on the operation apparatus 16. The content of the setting images UI transitions from one to another in accordance with the operation.

The setting image UI-1 has tabs T-1 to T-7, and regions Ra and Rb.

The tabs T-1 to T-7 are each a displayed object that can be selected by an operation performed on the operation apparatus 16. The tab T-1 is a displayed object for settings relating to image quality. The tab T-2 is a displayed object for settings relating to videos. The tab T-3 is a displayed object for basic settings. The tab T-4 is a displayed object for extended settings. The tab T-5 is a displayed object for settings relating to a network. The tab T-6 is a displayed object for settings relating to various kinds of information. The tab T-7 is a displayed object for initialization of settings.

Out of the tabs T-1 to T-7, the tab T-4 is operated when settings relating to the resolution and the aspect ratio of the entire image GG are made. Out of the tabs T-1 to T-7, the displayed objects other than the tab T-4 may be used as necessary and may be omitted.

When the tab T-4 is selected, the region Ra is first displayed. The region Ra has a button group BG1 and a button B2. The button group BG1 is a displayed object for settings to be made first in the extended settings, and has a button B1. The button B1 is a displayed object for accepting the operation of causing the content of the current setting image UI to transition to the content for setting the resolution, that is, the screen type of an image from the first projector 10-1. The button B2 is a displayed object for accepting the operation of causing the content of the current setting image UI to return to the state before the previous operation.

The region Rb is a displayed object for illustrating a method for operating the current setting image UI via the operation apparatus 16.

FIG. 5 illustrates the selection operation performed on the current setting image UI. When the button B1 is operated in the setting image UI-1 shown in FIG. 4, the setting image UI-2 is displayed in step S12, as shown in FIG. 5.

The setting image UI-2 is the same as the setting image UI-1 except that the tabs T-1 to T-7 and the region Ra of the setting image UI-1 are replaced with a region Rc, and therefore has the regions Rb and Rc.

The region Rc is a displayed object for accepting a selection operation of selecting one type of resolution from the multiple types of resolution of an image that the first projector 10-1 can project. The region Rc has multiple options S1 and the button B2.

The multiple options S1 correspond in a one-to-one manner to the multiple types of resolution of an image that the first projector 10-1 can project, and any one of the multiple options S1 can be selected through an operation performed on the operation apparatus 16. In the example shown in FIG. 5, the multiple options S1 correspond to multiple types of resolution according to aspect ratios of 4:3, 16:6, 16:9, 16:10, and 21:9.

The options S1 are each an option for specifying how many pixels are used in the light modulating elements of the first projector 10-1, that is, an option for specifying the resolution. Therefore, in the present embodiment, aspect ratios are displayed as the options S1 in the region Rc, and the aspect ratios are each associated in advance with the resolution in the third direction (first direction DR1) and the resolution in the fourth direction (second direction DR2). That is, multiple pairs are formed by associating the multiple aspect ratios and the multiple types of resolution with each other. For example, out of the multiple options S1, “4:3” is associated with resolution of 2880 px×2160 px. The symbol px is a unit representing the number of pixels or the resolution. Therefore, when “4:3” is selected, the first projector 10-1 uses, for example, 2880 pixels at the maximum in the third direction and 2160 pixels at the maximum in the fourth direction out of the multiple pixels. The user can therefore set the maximum resolution of the first projection image G1 projectable by the first projector 10-1 at 2880 px in the first direction DR1 and 2160 px in the second direction DR2, for example, by selecting “4:3” out of the multiple options S1.

The resolution of 2880 px×2160 px described above is an example of the first resolution. The first resolution includes first resolution in the first direction DR1 (2880 px, for example) and first resolution in the second direction DR2 (2160 px, for example). The first resolution in the first direction DR1 is an example of the number of pixels Wa of the light modulator 15b, which will be described later, in the lateral direction, and the first resolution in the second direction DR2 is an example of the number of pixels Ha of the light modulator 15b, which will be described later, in the longitudinal direction. Furthermore, the number and the display mode of the displayed options S1, the content of the pairs of the resolution and the aspect ratio corresponding to each other, and the like are not limited to those shown in FIG. 5, and may be determined in any manner.

When one of the multiple options S1 is selected, it is determined in step S12 described above that the selection operation has been performed (YES in step S12).

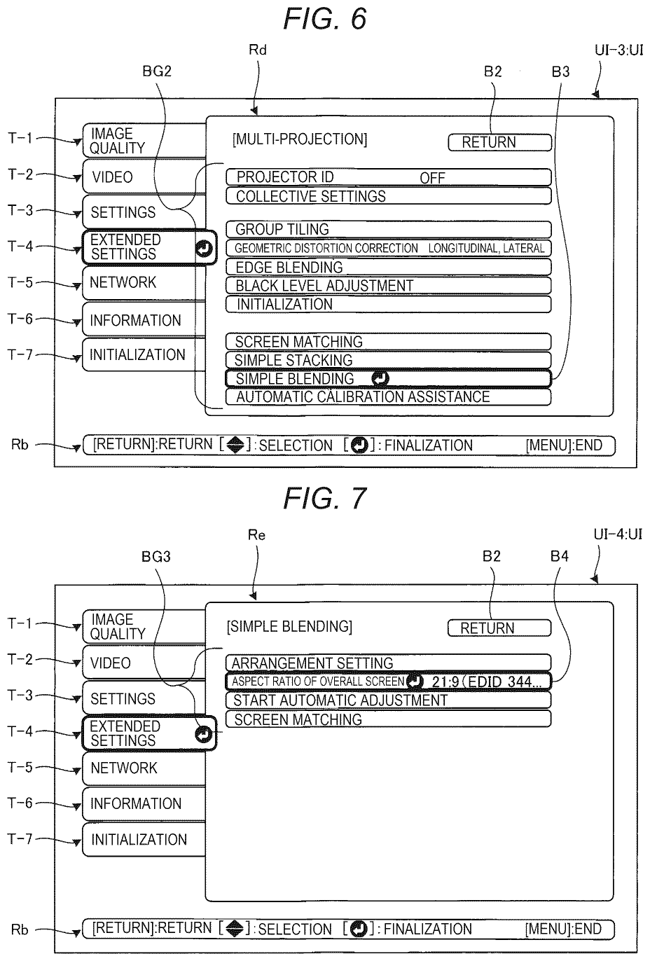

FIG. 6 illustrates the setting image UI-3 after the resolution is set. When the button B2 is operated on the setting image UI-2 shown in FIG. 5 after the selection operation is performed, the setting image UI-3 is displayed as shown in FIG. 6 for the period between steps S12 and S14.

The setting image UI-3 is the same as the setting image UI-1 except that the region Ra of the setting image UI-1 is replaced with a region Rd, and therefore has the tabs T-1 to T-7, and the regions Rb and Rd.

The region Rd is a displayed object for setting multi-projection. The region Rd has a group of multiple buttons BG2, and the buttons B2. The group of multiple buttons BG2 is a displayed object for settings to be made after the resolution of an image from the first projector 10-1 is set in the extended settings, and has a button B3. The button B3 is a displayed object for accepting the operation of causing the content of the current setting image UI to transition to a content for making settings relating to the entire image GG.

FIG. 7 illustrates the settings of the pair of the resolution and the aspect ratio of the entire image GG. When the button B3 is operated in the setting image UI-3 shown in FIG. 6, the setting image UI-4 is displayed as shown in FIG. 7 for the period from steps S12 to S14.

The setting image UI-4 is the same as the setting image UI-3 except that the region Rd of the setting image UI-3 is replaced with a region Re, and therefore has the tabs T-1 to T-7, and the regions Rb and Re.

The region Re is a displayed object for settings relating to the entire image GG. The region Re has a group of multiple buttons BG3, and the button B2. The group of buttons BG3 is a displayed object for various settings relating to the entire image GG, and has a button B4. The button B4 is a displayed object for accepting the operation for causing the content of the current setting image UI to transition to a content for setting the resolution and the aspect ratio of the entire image GG.

FIG. 8 shows an example of displayed multiple options S2 showing pairs of the resolution and the aspect ratio of the entire image GG. When the button B4 is operated in the setting image UI-4 shown in FIG. 7, the setting image UI-5 is displayed in step S14 as shown in FIG. 8. FIG. 8 shows the setting image UI-5 in a case where the resolution (aspect ratio) of 3840×1644 (21:9) has been selected in step S12. Note that 3840×1644 indicates 3840 px×1644 px.

The setting image UI-5 is the same as the setting image UI-1 except that the tabs T-1 to T-7 and the region Ra of the setting image UI-1 are replaced with a region Rf, and therefore has the regions Rb and Rf.

The region Rf is a displayed object for accepting the operation of selecting one pair from the multiple pairs of the resolution and the aspect ratio of the entire image GG. The region Rf has the multiple options S2 and the button B2.

The multiple options S2 correspond in a one-to-one manner to multiple pairs of the resolution and the aspect ratio of the entire image GG, and one of the multiple options S2 can be selected by an operation performed on the operation apparatus 16. In the example shown in FIG. 8, the multiple options S2 correspond to
a pair of the aspect ratio 21:9 and resolution (EDID) 3440×1440,
a pair of the aspect ratio 21:9 and resolution (EDID) 2560×1080,
a pair of the aspect ratio 16:6 and resolution (EDID) 2880×1080,
a pair of the aspect ratio 16:6 and resolution (EDID) 1920×720,
a pair of the aspect ratio 3:1 and resolution (EDID) 3240×1080,
a pair of the aspect ratio 32:10 and resolution (EDID) 3456×1080, and
a pair of the aspect ratio 21:9 and resolution (EDID) 3200×900.

Note that the number and the display mode of the displayed options S2, the content of the pair of the resolution and the aspect ratio corresponding to each other, and the like are not limited to those shown in FIG. 8, and may be determined in any manner. EDID is an abbreviation for extended display identification data. That is, EDID includes the resolution in the present embodiment. The resolution 3440×1440 described above is an example of the second resolution, and is expressed in px. The second resolution includes second resolution in the first direction DR1 (3440 px, for example) and second resolution in the second direction DR2 (1440 px, for example). The second resolution in the first direction DR1 is an example of the number of pixels W of the entire image GG, which will be described later, and the second resolution in the second direction DR2 is an example of the number of pixels H of the entire image GG, which will be described later.

When one of the multiple options S2 is selected by an operation performed on the operation apparatus 16, it is determined in step S15 that one option S2 has been selected (YES in step S15). In step S16, the setting information D1 representing the pair of the resolution and the aspect ratio corresponding to the selected option S2 is generated. The pair of the resolution and the aspect ratio indicated by the setting information D1 is thus set as the resolution and the aspect ratio of the entire image GG.

In the setting image UI-5, the user needs to select one of the multiple options S2 by operating the operation apparatus 16 after visually recognizing the multiple options S2. To improve the usability of the system, in step S14, the setting section 12a causes the multiple options S2 to be displayed differently in accordance with the condition of at least one parameter that defines the entire image GG.

That is, in step S14, the setting section 12a causes the display mode of options S2-a, which are options S2 corresponding to pairs of the resolution and the aspect ratio that satisfy the condition of at least one parameter that defines the entire image GG out of the multiple options S2 to differ from the display mode of options S2-b, which are the other options S2. Which resolution of the entire image GG satisfies the condition can therefore be readily grasped in an intuitive manner. The usability of the system can thus be improved.

It is preferable to disable the operation of selecting an option S2 corresponding to a pair of the resolution and the aspect ratio that does not satisfy the condition out of the multiple options S2. The user's erroneous selection of the entire image GG that does not have the number of pixels X, which is an optimum overlap width, which will be described later, can thus be avoided.

In the example shown in FIG. 8, the display mode of the options S2-a indicates that they are selectable, whereas the display mode of the options S2-b indicates that they are not selectable. Note that the display modes of the options S2-a and S2-b are not limited to those shown in FIG. 8. For example, the options S2-b may instead, for example, be grayed out so as to less stand out than the options S2-a. Still instead, the options S2-b corresponding to pairs of the resolution and the aspect ratio that do not satisfy the condition may be selectable. In this case, however, it is essential that the options S2-a corresponding to pairs of the resolution and aspect ratio that satisfies the condition are selectable. In this case, it is further preferable to display the options S2-b in a display mode in which a note or the like relating to the display mode of the entire image GG is displayed when any of the options S2-b is selected.

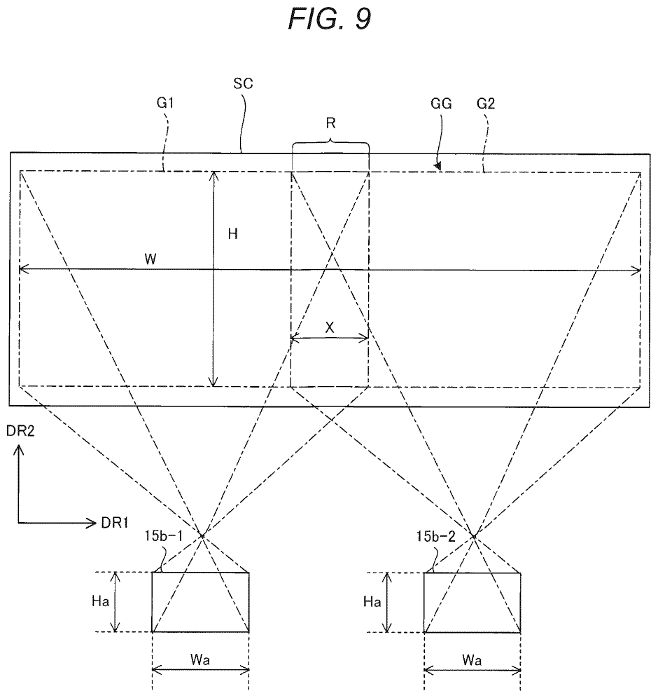

FIG. 9 illustrates the relationship of the resolution and the aspect ratio of the entire image GG with the resolution and the aspect ratio of light modulators 15b-1 and 15b-2. Let W be the number of pixels of the entire image GG in the first direction DR1, Ha be the number of pixels of each of the light modulator 15b in the longitudinal direction (fourth direction), Hb be the number of the resolution corresponding to any of the options S2 pixels in the longitudinal direction (third direction), and Wb be the number of pixels of the resolution corresponding to the option S2 in the lateral direction, and the number of pixels W is expressed by W=Ha×(Wb/Hb). Wb/Hb corresponds to the aspect ratio of the entire image GG that the user desires to construct. The number of pixels Ha is in other words the number of pixels, in the second direction DR2, of the resolution of an image that the projectors 10 can each project. The number of pixels Ha is an example of the first resolution in the second direction perpendicular to the first direction. The number of pixels W of the entire image GG in the first direction DR1 is an example of the second resolution of the entire image in the first direction.

Let X be the number of pixels of the overlap region R in the first direction DR1, and Wa be the number of pixels of each of the light modulators 15b in the lateral direction, and the number of pixels X is expressed by X=(Wa+Wa)−W=(Wa×2)−W. The number of pixels of the overlap region R in the first direction DR1 is an example of the resolution of the overlap region in the first direction. The number of pixels Wa is an example of the first resolution of the first projection image in the first direction DR1. The number of pixels Wa is the maximum number of pixels of each of the light modulators 15b that are used in the first direction DR1. That is, the number of pixels of the overlap region R in the first direction DR1 is calculated based on the number of pixels Wa of the first projection image G1 in the first direction DR1, the number of pixels Wa of the second projection image G2 in the first direction DR1, the number of pixels Ha in the second direction DR2, and the aspect ratio Wb/Hb of the entire image GG. Note that the number of pixels Wa is in other words the number of pixels, in the first direction DR1, of the resolution of an image that the projectors 10 can each project.

When a first ratio X/Wa, which is the ratio of the number of pixels X to the number of pixels Wa, is too small, the number of pixels X cannot be sufficiently secured. For example, it is difficult to correct an image in the overlap region R by using the result of imaging performed by the imaging apparatus 17 depending on the resolution of the imaging apparatus 17. On the other hand, when the first ratio X/Wa is too large, it is difficult to provide the advantage of configuring the entire image GG with the first projection image G1 and the second projection image G2. The first ratio X/Wa indicates the number of pixels X that occupy the overlap region R out of the number of pixels Wa of the first projection image G1 in the first direction DR1.

In view of the fact described above, the first ratio X/Wa is used in step S14 as a parameter of the condition under which an option S2 is determined as an options S2-a. That is, the parameter used in step S14 is the first ratio X/Wa, which is the ratio of the number of pixels X of the overlap region R in the first direction DR1, which is the direction in which the first projection image G1 and the second projection image G2 are arranged, to the number of pixels Wa of the first projection image G1 in the first direction DR1. The condition in step S14 is that the first ratio X/Wa does not fall within a first range. The thus set condition readily allows grasp of which entire image GG does not have the optimal overlap width. The number of pixels X of the overlap region R in the first direction DR1 is calculated by the expression described above based on the resolution of each of the first projection image G1 and the second projection image G2 and the aspect ratio of the entire image GG, the resolution and the aspect ratio selected based on the selection operation.

The lower limit of the first range is preferably 12.5%. The number of pixels X can thus be sufficiently secured. The lower limit of the first range is an example of a first value greater than zero. The upper limit of the first range is preferably 708. The upper limit of the first range is an example of a second value greater than zero and greater than the first value. That is, the situation in which the first ratio X/Wa does not fall within the first range means that the first ratio X/Wa is smaller than the lower limit of the first range or greater than the upper limit of the first range. The advantage of configuring the entire image GG by using the first projection image G1 and the second projection image G2 can thus be readily provided.

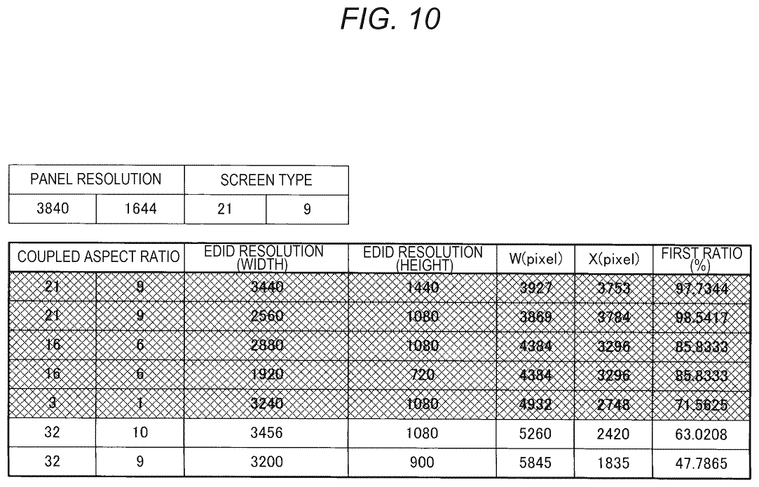

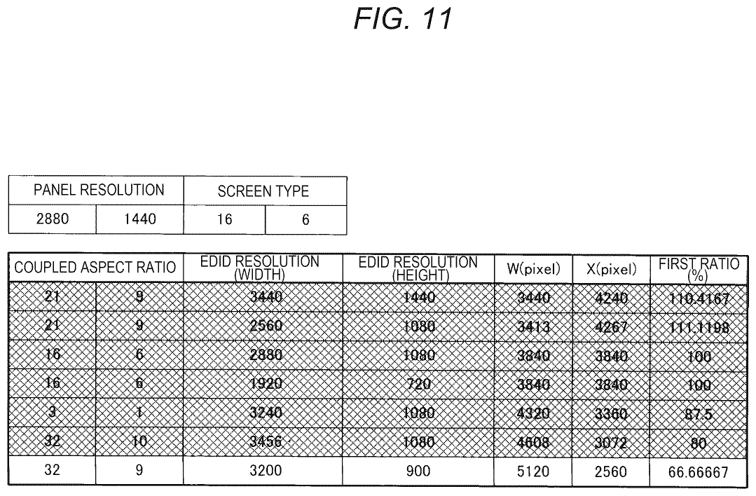

FIGS. 10 and 11 illustrate an example of pairs of the resolution and the aspect ratio of the entire image GG.

FIG. 10 shows the relationship of the resolution and the aspect ratio of the entire image GG with the numbers of pixels W and X and the first ratio X/Wa in a case where the resolution (aspect ratio) selected in step S12 is 3840×1644 (21:9). FIG. 11 shows the relationship of the resolution and the aspect ratio of the entire image GG with the numbers of pixels W and X and the first ratio X/Wa in a case where the resolution (aspect ratio) selected in step S12 is 2880×1440 (16:6).

In the examples shown in FIGS. 10 and 11, some of the multiple pairs of the resolution and the aspect ratio of the entire image GG show that the first ratio X/Wa exceeds 70%. Therefore, when the resolution (aspect ratio) selected in step S12 is 3840×1644 (21:9) or 2880×1440 (16:6), the options S2 corresponding to the pairs of the resolution and the aspect ratio of the entire image GG and showing that the first ratio X/Wa exceeding 70% are the options S2-b in step S14.

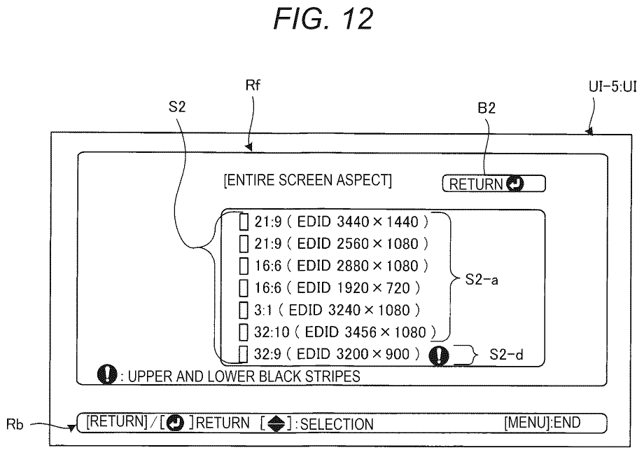

FIG. 12 shows another example of the displayed multiple options S2 showing pairs of the resolution and the aspect ratio of the entire image GG. FIG. 12 shows the setting image UI-5 in a case where the resolution (aspect ratio) of 3840×2160 (16:9) is selected in step S12.

Let H be the number of pixels of the entire image GG in the second direction DR2, and securing the overlap region R undesirably produces upper and lower black stripes, that are regions not used to draw the first projection image G1 and the second projection image G2, in upper and lower portions of the projection images when the number of pixels H is smaller than the number of pixels Ha, that is, when a second ratio H/Ha, which is the ratio of the number of pixels H to the number of pixels Ha, is greater than or equal to zero but smaller than one.

For example, it is assumed in step S13 that it has been determined that the number of pixels Wa is 3456 px and the number of pixels Ha is 2160 px in each of the first projector 10-1 and the second projector 10-2. It is further assumed that an option S2 showing, for example, a pair of the aspect ratio of 32:10 and the resolution (EDID) of 3456×1080 has been selected. In this case, the number of pixels W of the entire image GG is Ha×(Wb/Hb)=2160×(3456/1080)=6912 px. The value is exactly twice the number of pixels Wa. In this case, even if an entire image GG having the aspect ratio of 32:10 and the resolution (EDID) of 3456×1080 is constructed, the number of pixels X of the overlap region R is zero, that is, the first ratio X/Wa=0, so that the preferable lower limit of 12.5% is not satisfied.

Therefore, in the present embodiment, the actual number of pixels W of the overall image GG is so corrected that 12.5% of 3456 px, that is, 432 px is, for example, secured as the number of pixels X of the overlap region R. Specifically, 6480 px as a result of subtraction of 432 px from 6912 px is employed as the actual number of pixels W of the entire image GG. At this point in time, since the user desires to eventually construct the entire image GG having the aspect ratio of 32:10, the number of pixels H of the entire image GG is calculated to be 6480 px (W)×(10/32)=2025 px when the number of pixels W of the entire image GG is 6480 px. The value of 2025 px corresponds to H of the second ratio H/Ha, which will be described later. Since the number of pixels Ha is determined to be 2160 px in step S13 as described above, the first projector 10-1 and the second projector 10-2 can intrinsically use the number of pixels Ha=2160 px at the maximum. However, to construct the entire image GG having the aspect ratio of 32:10, the number of pixels H of the entire image GG should actually be set at 2025 px, as indicated by the calculation described above, so that the number of pixels H is smaller than the number of pixels Ha in the second direction DR2 by 135 px, which is the result of subtraction of 2025 px from 2160 px. A black stripe according to the difference between the number of pixels H and the number of pixels Ha is therefore produced in the first projection image G1 and the second projection image G2 in the second direction DR2. In this case, the second ratio H/Ha defined above is calculated to be 2025/2160=0.9375. That is, it can be said that the second ratio H/Ha is an index used to determine whether a black stripe is produced in the first projection image G1 and the second projection image G2 in the second direction DR2. Note that when a black stripe is produced in neither the first projection image G1 nor the second projection image G2 in the second direction DR2, the second ratio H/Ha is greater than one. That is, when the number of pixels H is greater than the number of pixels Ha, a black stripe is produced in neither the first projection image G1 nor the second projection image G2. When the number of pixels H is greater than the number of pixels Ha, several pixels out of the pixels that constitute the number of pixels H are so thinned out that the resultant number of pixels H is smaller than or equal to the number of pixels Ha.

In view of the fact described above, the second ratio H/Ha is used in step S14 as a parameter of the condition under which an option S2 is determined as an options S2-a. That is, the parameter used in step S14 is the second ratio H/Ha of the number of pixels H of the entire image GG in the second direction DR2, which is the direction perpendicular to the first direction DR1, in which the first projection image G1 and the second projection image G2 are arranged, to the number of pixels Ha of the first projection image G1 in the second direction DR2. The number of pixels H of the entire image GG in the second direction DR2 is an example of the second resolution of the entire image GG in the second direction. The number of pixels H of the entire image GG in the second direction DR2 is calculated based on the number of pixels W of the entire image GG in the first direction DR1 and the aspect ratio of the entire image GG. The condition in step S14 is that the second ratio H/Ha is smaller than one. The thus set condition readily allows grasp of which entire image GG has black stripes produced in upper and lower portions. Note that since the second ratio H/Ha is a positive number, the condition may be so set that the second ratio H/Ha is greater than or equal to zero or but smaller than one.

In the example shown in FIG. 12, in step S14, the setting section 12a causes the display mode of options S2-a, which are options S2 corresponding to pairs of the resolution and the aspect ratio that satisfy the condition of at least one parameter that defines the entire image GG out of the multiple options S2 to differ from the display mode of an option S2-d, which is the other options S2.

The option S2-d is selectable, but the display mode thereof indicates that upper and lower black stripes, that are regions not used to draw the first projection image G1 and the second projection image G2, are produced in upper and lower portions of the projection images. In the example shown in FIG. 12, a displayed object “!” is added to the option S2-c, and a description of the display object “!” is displayed in the setting image UI. The display mode of the option S2-c is not limited to that shown in FIG. 12. For example, the option S2-c may instead, for example, be grayed out so as to stand out less than the options S2-a. Still instead, the option S2-c may be non-selectable, as the options S2-b described above.

The parameter used in step S14 may include the first ratio X/Wa and the second ratio H/Ha described above. In this case, the condition in step S14 is that the first ratio X/Wa does not fall within the first range and the second ratio H/Ha is greater than or equal to zero but smaller than one. The thus set condition readily allows grasp of which entire image GG does not have an overlap width that is the width of an optimum overlap region R but has upper and lower black stripes.

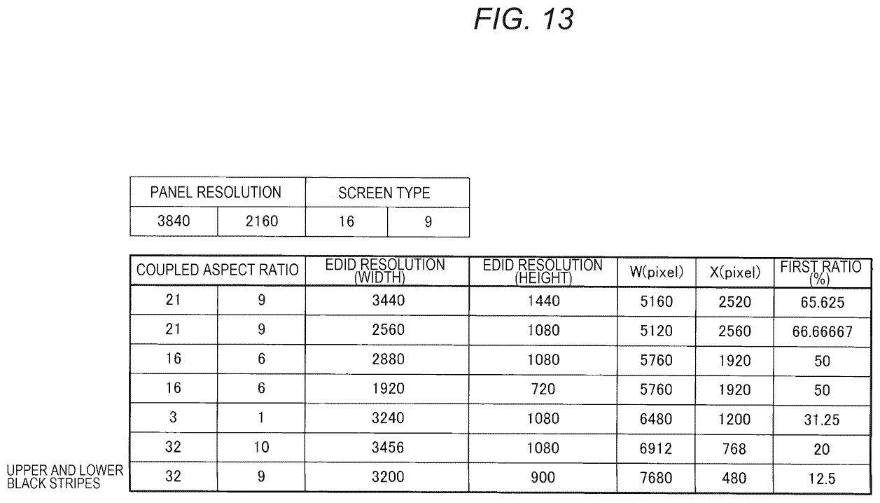

FIGS. 13 to 15 each illustrate an example of pairs of the resolution and the aspect ratio of the entire image GG.

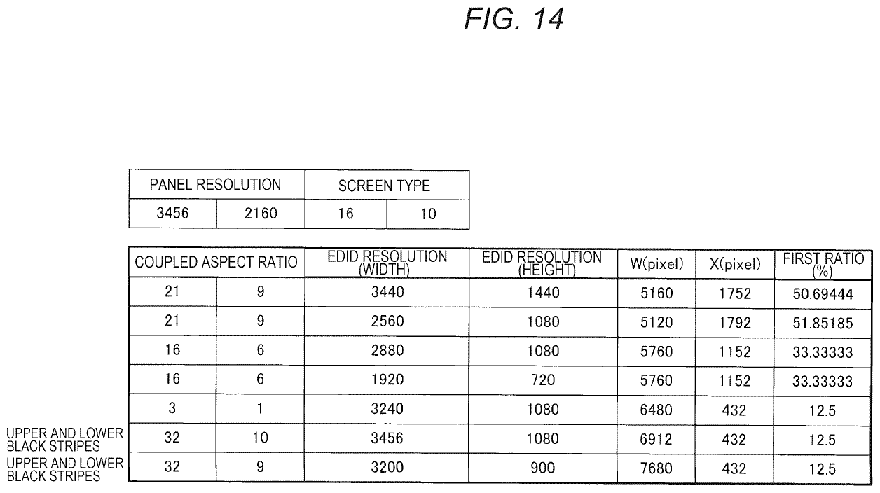

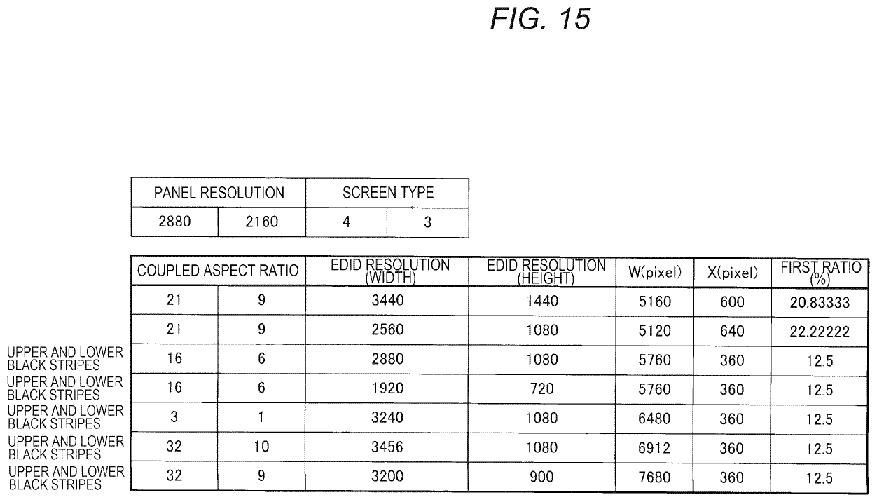

FIG. 13 shows the relationship of the resolution and the aspect ratio of the entire image GG with the numbers of pixels W and X and the first ratio X/Wa in a case where the resolution (aspect ratio) selected in step S12 is 3840×2160 (16:9). FIG. 14 shows the relationship of the resolution and the aspect ratio of the entire image GG with the numbers of pixels W and X and the first ratio X/Wa in a case where the resolution (aspect ratio) selected in step S12 is 3456×2160 (16:10). FIG. 15 shows the relationship of the resolution and the aspect ratio of the entire image GG with the numbers of pixels W and X and the first ratio X/Wa in a case where the resolution (aspect ratio) selected in step S12 is 2880×2160 (4:3).

In the examples shown in FIGS. 13 and 15, some of the multiple pairs of the resolution and the aspect ratio of the entire image GG show that the second ratio H/Ha is greater than or equal to one. Therefore, when the resolution (aspect ratio) selected in step S12 is 3840×2160 (16:9), 3456×2160 (16:10), or 2880×2160 (4:3), the option S2 corresponding to the pair of the resolution and the aspect ratio of the entire image GG and showing that the second ratio H/Ha greater than or equal to one is the option S2-d in step S14.

### 2. Second Embodiment

A second embodiment of the present disclosure will be described below. In the form described below by way of example, elements having the same effects and functions as those in the first embodiment have the same reference characters used in the description of the first embodiment, and will not be described in detail as appropriate.

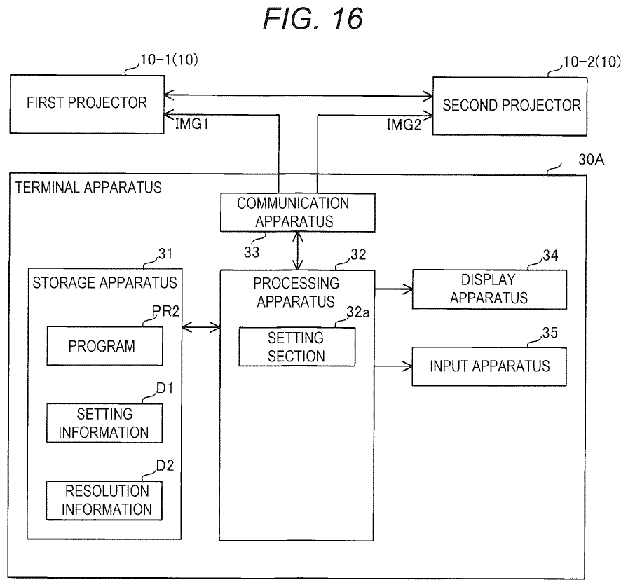

FIG. 16 is a block diagram of a terminal apparatus 30A used to perform a display method according to a second embodiment. The terminal apparatus 30A is an example of a “computer”, and is configured in the same manner as the terminal apparatus 30 in the first embodiment except that the terminal apparatus 30A executes a program PR2. Note in the present embodiment that the program PR1 in the first embodiment may be omitted.

The terminal apparatus 30A includes a storage apparatus 31, a processing apparatus 32, a communication apparatus 33, a display apparatus 34, and an input apparatus 35, as shown in FIG. 16. The apparatuses are communicatively connected to each other.

The storage apparatus 31 is a storage apparatus that stores programs to be executed by the processing apparatus 32 and data to be processed by the processing apparatus 32. The storage apparatus 31 includes, for example, a hard disk drive or a semiconductor memory. Note that a portion or the entirety of the storage apparatus 31 may be provided in a storage apparatus, a server, or the like outside the terminal apparatus 30A.

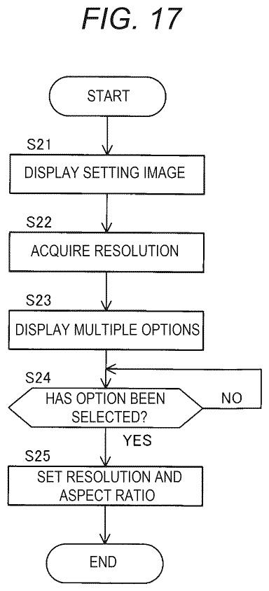

The storage apparatus 31 stores the program PR2, the setting information D1, and resolution information D2. The program PR2 is a program that performs a display method described later in detail with reference to FIG. 17. The resolution information D2 includes one or both of first information representing the maximum resolution of an image that the first projector 10-1 can project and second information representing the maximum resolution of an image that the second projector 10-2 can project.

The processing apparatus 32 is a processing apparatus having the function of controlling each section of the terminal apparatus 30A and the function of processing various kinds of data. The processing apparatus 32 includes, for example, a processor such as a CPU. Note that the processing apparatus 32 may be configured with a single processor or multiple processors. Some or all of the functions of the processing apparatus 32 may be realized by hardware such as a DSP, an ASIC, a PLD, and an FPGA.

The communication apparatus 33 is a communication apparatus capable of communicating with various instruments, and communicates with the first projector 10-1 and the second projector 10-2. For example, the communication apparatus 33 is a wired communication apparatus using, for example, a wired LAN, a USB, or an HDMI, or a wireless communication apparatus using, for example, an LPWA, a wireless LAN including Wi-Fi, or Bluetooth. “HDMI”, “Wi-Fi”, and “Bluetooth” are each a registered trademark.

The display apparatus 34 displays various images under the control by the processing apparatus 32. The display apparatus 34 includes a display panel, such as a liquid crystal display panel or an organic EL (electro-luminescence) display panel.

The input apparatus 35 is an instrument that accepts the user's operation. For example, the input apparatus 35 includes a pointing device such as a touch pad, a touch panel, or a mouse. When the input apparatus 35 includes a touch panel, the input apparatus 35 may also serve as the display apparatus 34. Note that the input apparatus 35 may be provided outside the terminal apparatus 30A. The input apparatus 35 may include another input instrument such as a keyboard.

In the terminal apparatus 30A described above, the processing apparatus 32 functions as a setting section 32a by executing the program PR2 stored in the storage apparatus 31. The processing apparatus 32 therefore includes the setting section 32a.

The setting section 32a sets the resolution and the aspect ratio of the entire image GG. Specifically, the setting section 32a acquires the resolution information D2 based on one or both of the first information acquired from the first projector 10-1 and the second information acquired from the second projector 10-2, and causes the display apparatus 34 to display the setting images UI necessary for setting the resolution and the aspect ratio of the entire image GG based on the resolution information D2. The setting section 32a further performs processing necessary for setting the resolution and the aspect ratio of the entire image GG based on operations performed on the setting images UI via the input apparatus 35.

FIG. 17 is a flowchart showing the procedure of the display method according to the second embodiment. The display method is performed by using the terminal apparatus 30A described above to cause the processing apparatus 32 to execute the program PR2. The display method includes steps S21 to S25, as shown in FIG. 17. That is, the terminal apparatus 30A executes steps S21 to S25. The program PR2 causes the terminal apparatus 30A, which is an example of a computer, to execute steps S21 to S25.

Specifically, in step S21, the setting section 32a first causes the display apparatus 34 to display the setting images UI. In the present embodiment, the display operation is performed by causing the setting section 32a to control the operation of driving the display apparatus 34 to cause the display apparatus 34 to display the setting image UI-1 shown in FIG. 4 described above. Step S21 starts, for example, in response to a predetermined operation performed on the input apparatus 35.

After step S21, the setting section 32a acquires in step S22 resolution of images that one or both of the first projector 10-1 and the second projector 10-2 can project. The resolution information D2 is thus acquired. The acquisition is made through communication that the setting section 32a performs with one or both of the first projector 10-1 and the second projector 10-2 via the communication apparatus 33.

As described above, the setting section 32a acquires in step S22 one or both of the first information representing the maximum resolution of an image that the first projector 10-1 can projected and the second information representing the maximum resolution of an image that the second projector 10-2 can project.

After step S22, the setting section 32a causes in step S23 the display apparatus 34 to display the multiple options S2. In the present embodiment, the display operation is performed by causing the setting section 32a to control the operation of driving the display apparatus 34 to cause the display apparatus 34 to display the setting image UI-5 shown in FIG. 8 described above.

As described above, the setting section 32a causes in step S23 the display apparatus 34 to display the multiple options S2 for selecting one from the multiple pairs of the resolution and aspect ratio of the entire image GG, which is configured with the first projection image G1 and the second projection image G2, based on the first information and the second information.

In step S23, the display mode of the options corresponding to pairs of the resolution and the aspect ratio of the entire image GG that the first projector 10-1 and the second projector 10-2 can project out of the multiple options S2 is caused to differ from the display mode of the other options S2, as in step S14 in the first embodiment.

After step S23, the setting section 32a determines whether one option S2 has been selected from the multiple options S2, as in step S15 described above. Step S24 is repeatedly executed until the operation of selecting one option S2 is performed (NO in step S24).

When one option S2 has been selected (YES in step S24), the setting section 32a sets in step S25 the pair of the resolution and the aspect ratio corresponding to the selected option S2 as the resolution and the aspect ratio of the entire image GG. The thus set resolution and the aspect ratio are stored as the setting information D1 in the storage apparatus 31. The setting section 32a then transmits the setting information D1 stored in the storage apparatus 31 to one or both of the first projector 10-1 and the second projector 10-2 via the communication apparatus 33.

Also according to the second embodiment described above, the display mode of the options S2 corresponding to the pair of the resolution and the aspect ratio of the entire image GG that the first projector 10-1 and the second projector 10-2 can project is caused to differ from the display mode of the other options S2, so that which resolution of the entire image GG satisfies the condition can be readily grasped in an intuitive manner. The usability of the system can thus be improved.

### 3. Variations

The forms shown above by way of example can be changed in various manners. Aspects of specific changes applicable to the embodiments described above are shown below by way of example. Any two or more aspects selected from the examples shown below can be combined with each other as appropriate to the extent that no contradiction occurs.

### 3-1. Variation 1

In the embodiments described above, the first projection image G1 and the second projection image G2 are arranged in the lateral direction, but not necessarily. For example, the first projection image G1 and the second projection image G2 may be arranged in the longitudinal direction. That is, the first direction DR1 is not limited to the horizontal direction, and may, for example, be the vertical direction. The first direction DR1 does not necessarily coincide with the lateral direction of the first projection image G1 or the second projection image G2. For example, the first direction DR1 may coincide with the longitudinal direction of the first projection image G1 or the second projection image G2.

### 3-2. Variation 2

In the embodiments described above, the options S2 each show the resolution and the aspect ratio of the entire image GG, but not necessarily. Specifically, as long as the first projector 10-1 and the second projector 10-2 can recognize the resolution and the aspect ratio of the entire image GG to be projected in response to the selection of an option S2, the options S2 may each show one of the resolution and the aspect ratio of the entire image GG. For example, the options S2 may each show only the aspect ratio, and the pair of the aspect ratio of 21:9 and the resolution (EDID) of 3440×1440, and the pair of the aspect ratio of 21:9 and the resolution (EDID) of 2560×1080 may be displayed as: the aspect ratio of 21:9 (high resolution); and the aspect ratio of 21:9 (low resolution). As another example, the options S2 may each show only the resolution of the entire image GG, that is, EDID.

### 3-3. Variation 3

When at least one of the programs PR1 and PR2 is realized by using a computer provided in the terminal apparatus 30 (30A) or a computer provided in at least one of the first projector 10-1 and the second projector 10-2, the program to be executed by the computer can be configured in the form of a computer readable, non-transitory recording medium. Instead, the program can also be configured in the form of a transmission medium that transmits the program to be executed by the computer. The recording medium can be a magnetic or optical recording medium or a semiconductor memory device. Specific examples of the recording medium may include portable or immobile recording media such as a flexible disc, a hard disk drive (HDD), a CD-ROM, a digital versatile disc (DVD), a Blu-ray disc, a magneto-optical disk, a flash memory, and a card-shaped recording medium. The recording medium described above may be a nonvolatile storage apparatus such as a RAM, a ROM, or an HDD that is an internal storage apparatus provided in a server apparatus. Blu-ray is a registered trademark.

### 4. Additional Remarks

The present disclosure will be summarized below in the form of additional remarks.

(Additional remark 1) A first aspect that is a preferable example of a display method according to the present disclosure is a display method for causing a first projection image projected from a first projector onto a projection surface and a second projection image projected from a second projector onto the projection surface to partially overlap with each other in an overlap region of the projection surface, the t display method including: determining first resolution of each of the first and second projection images that the first and second projectors are configured to project; and displaying multiple options for defining an entire image configured with the first and second projection images, the multiple options each including at least one of second resolution indicating resolution of the entire image and an aspect ratio of the entire image, displaying the multiple options including causing a display mode of an option corresponding to resolution and an aspect ratio that satisfy a condition of at least one parameter that defines the entire image out of the multiple options to differ from a display mode of another option based on the first resolution.

According to the aspect described above, the display mode of the option corresponding to the pair of the resolution and the aspect ratio that satisfy the condition of the at least one parameter, which defines the entire image, is caused to differ from the display mode of the other option, so that which resolution of the entire image satisfies the condition can be readily grasped in an intuitive manner. The usability of the method can thus be improved.

(Additional remark 2) In a second aspect that is a preferable example of the first aspect, the at least one parameter is a first ratio that is a ratio of resolution of the overlap region in a first direction in which the first and second projection images are arranged to the first resolution of the first projection image in the first direction, the condition is that the first ratio does not fall within a first range, and the resolution of the overlap region in the first direction is calculated based on the first resolution of the first projection image in the first direction, the first resolution of the second projection image in the first direction, the first resolution in a second direction perpendicular to the first direction, and the aspect ratio of the entire image. The aspect described above readily allows grasp of which entire image does not have an optimal overlap width.

(Additional remark 3) In a third aspect that is a preferable example of the first aspect, the at least one parameter is a second ratio of the second resolution in the second direction to the first resolution of the first projection image in the second direction, the second resolution in the second direction is calculated based on the second resolution in the first direction and the aspect ratio, and the condition is that the second ratio is greater than or equal to zero but smaller than one. The aspect described above readily allows grasp of which entire image has upper and lower black stripes.

(Additional remark 4) In a fourth aspect that is a preferable example of the first aspect, the at least one parameter includes a first ratio that is a ratio of resolution of the overlap region in a first direction in which the first and second projection images are arranged to the first resolution of the first projection image in the first direction, and a second ratio of the second resolution of the entire image in a second direction perpendicular to the first direction to the first resolution of the first projection image in the second direction, the resolution of the overlap region in the first direction is calculated based on the first resolution of the first projection image in the first direction, the first resolution of the second projection image in the first direction, the first resolution in the second direction, and the aspect ratio of the entire image, the second resolution in the second direction is calculated based on the second resolution in the first direction and the aspect ratio, and the condition is that the second ratio is greater than or equal to zero but smaller than one. The aspect described above readily allows grasp of which entire image does not have an optimum overlap width but has upper and lower black stripes.

(Additional remark 5) In a fifth aspect that is a preferable example of any of the first to fourth aspects, the method further includes disabling the operation of selecting an option corresponding to resolution and an aspect ratio that satisfy the condition out of the multiple options. The aspect described above can prevent the user from erroneously selecting the entire image that does not have the optimum overlap width.

(Additional remark 6) In a sixth aspect that is a preferable example of any of the first to fifth aspects, the method further includes causing a computer configured to control the first and second projectors to acquire one or both of first information representing maximum resolution of an image that the first projector is configured to project and second information representing maximum resolution of an image that the second projector is configured to project, the first resolution of the first projection image is determined based on the first information, and the first resolution of the second projection image is determined based on the second information.

In the aspect described above, the display mode of an option corresponding to the pair of the resolution and the aspect ratio of the entire image that can be projected by the first and second projectors is caused to differ from the display mode of another option, so that which resolution of the entire image satisfies the condition can be readily grasped in an intuitive manner. The usability of the method can thus be improved.

(Additional remark 7) A seventh aspect that is a preferable example of a projector according to the present disclosure is a projector used as a first projector when a first projection image projected from the first projector onto a projection surface and a second projection image projected from a second projector onto the projection surface are caused to partially overlap with each other in an overlap region of the projection surface, the projector including: an optical apparatus; and a processing apparatus configured to control an operation of the optical apparatus, the processing apparatus configured to determine first resolution of each of the first and second projection images that the first and second projectors are configured to project, and display multiple options for defining an entire image configured with the first and second projection images, the multiple options each including at least one of second resolution indicating resolution of the entire image and an aspect ratio of the entire image, displaying the multiple options including causing a display mode of an option corresponding to resolution and an aspect ratio that satisfy a condition of at least one parameter that defines the entire image out of the multiple options to differ from a display mode of another option based on the first resolution.

According to the aspect described above, the display mode of the option corresponding to the pair of the resolution and the aspect ratio that satisfy the condition of the at least one parameter, which defines the entire image, is caused to differ from the display mode of the other option, so that which resolution of the entire image satisfies the condition can be readily grasped in an intuitive manner. The usability of the projector can thus be improved.

(Additional remark 8) An eighth aspect that is a preferable example of a recording medium on which a program is recorded according to the present disclosure is a recording medium on which a program is recorded for causing a first projection image projected from a first projector onto a projection surface and a second projection image projected from a second projector onto the projection surface to partially overlap with each other in an overlap region of the projection surface, the recording medium on which a program is recorded causing a computer to: determine first resolution of each of the first and second projection images that the first and second projectors are configured to project; and display multiple options for defining an entire image configured with the first and second projection images, the multiple options each including at least one of second resolution indicating resolution of the entire image and an aspect ratio of the entire image, displaying the multiple options including causing a display mode of an option corresponding to resolution and an aspect ratio that satisfy a condition of at least one parameter that defines the entire image out of the multiple options to differ from a display mode of another option based on the first resolution.

According to the aspect described above, the display mode of the option corresponding to the pair of the resolution and the aspect ratio that satisfy the condition of the at least one parameter, which defines the entire image, is caused to differ from the display mode of the other option, so that which resolution of the entire image satisfies the condition can be readily grasped in an intuitive manner. The usability of the projector can thus be improved.

What is claimed is:

1. A display method for causing a first projection image projected from a first projector onto a projection surface and a second projection image projected from a second projector onto the projection surface to partially overlap with each other in an overlap region of the projection surface, the display method comprising:
determining first resolution of each of the first and second projection images that the first and second projectors are configured to project; and
displaying multiple options for defining an entire image configured with the first and second projection images,
wherein the multiple options each include at least one of second resolution indicating resolution of the entire image and an aspect ratio of the entire image, and
displaying the multiple options includes causing a display mode of an option corresponding to resolution and an aspect ratio that satisfy a condition of at least one parameter that defines the entire image out of the multiple options to differ from a display mode of another option based on the first resolution.

2. The display method according to claim 1, wherein
the at least one parameter is a first ratio that is a ratio of resolution of the overlap region in a first direction in which the first and second projection images are arranged to the first resolution of the first projection image in the first direction,
the condition is that the first ratio does not fall within a first range, and
the resolution of the overlap region in the first direction is calculated based on the first resolution of the first projection image in the first direction, the first resolution of the second projection image in the first direction, the first resolution in a second direction perpendicular to the first direction, and the aspect ratio of the entire image.

3. The display method according to claim 2, wherein
the at least one parameter is a second ratio of the second resolution in the second direction to the first resolution of the first projection image in the second direction,
the second resolution in the second direction is calculated based on the second resolution in the first direction and the aspect ratio, and
the condition is that the second ratio is greater than or equal to zero but smaller than one.

4. The display method according to claim 1, wherein
the at least one parameter includes
a first ratio that is a ratio of resolution of the overlap region in a first direction in which the first and second projection images are arranged to the first resolution of the first projection image in the first direction, and
a second ratio of the second resolution of the entire image in a second direction perpendicular to the first direction to the first resolution of the first projection image in the second direction,
the resolution of the overlap region in the first direction is calculated based on the first resolution of the first projection image in the first direction, the first resolution of the second projection image in the first direction, the first resolution in the second direction, and the aspect ratio of the entire image,
the second resolution in the second direction is calculated based on the second resolution in the first direction and the aspect ratio, and
the condition is that the second ratio is greater than or equal to zero but smaller than one.

5. The display method according to claim 1, further comprising
disabling the operation of selecting an option corresponding to resolution and an aspect ratio that satisfy the condition out of the multiple options.

6. The display method according to claim 1, further comprising
causing a computer configured to control the first and second projectors to acquire one or both of first information representing maximum resolution of an image that the first projector is configured to project and second information representing maximum resolution of an image that the second projector is configured to project,
the first resolution of the first projection image is determined based on the first information, and
the first resolution of the second projection image is determined based on the second information.

7. A projector used as a first projector when a first projection image projected from the first projector onto a projection surface and a second projection image projected from a second projector onto the projection surface are caused to partially overlap with each other in an overlap region of the projection surface, the projector comprising:
an optical apparatus; and
a processing apparatus configured to control an operation of the optical apparatus,
wherein the processing apparatus is configured to
determine first resolution of each of the first and second projection images that the first and second projectors are configured to project, and
display multiple options for defining an entire image configured with the first and second projection images,
the multiple options each includes at least one of second resolution indicating resolution of the entire image and an aspect ratio of the entire image, and
displaying the multiple options includes causing a display mode of an option corresponding to resolution and an aspect ratio that satisfy a condition of at least one parameter that defines the entire image out of the multiple options to differ from a display mode of another option based on the first resolution.

8. A recording medium on which a program is recorded for causing a first projection image projected from a first projector onto a projection surface and a second projection image projected from a second projector onto the projection surface to partially overlap with each other in an overlap region of the projection surface, the recording medium on which a program is recorded causing a computer to:
determine first resolution of each of the first and second projection images that the first and second projectors are configured to project; and
display multiple options for defining an entire image configured with the first and second projection images,
wherein the multiple options each includes at least one of second resolution indicating resolution of the entire image and an aspect ratio of the entire image, and
displaying the multiple options includes causing a display mode of an option corresponding to resolution and an aspect ratio that satisfy a condition of at least one parameter that defines the entire image out of the multiple options to differ from a display mode of another option based on the first resolution.
